(19) United States
(12) Patent Application Publication
(10) Pub. No.: US 2022/0417000 A1
(43) Pub. Date: Dec. 29, 2022

(54) RANDOM POSITION CIPHER ENCRYPTION USING SCRAMBLED ASCII STRINGS

(71) Applicant: PANAGIOTIS ANDREADAKIS, ALIMOS (GR)

(72) Inventor: PANAGIOTIS ANDREADAKIS, ALIMOS (GR)

(21) Appl. No.: 17/356,245

(22) Filed: Jun. 23, 2021

(51) Int. Cl. H04L 9/06; H04L 9/08

(52) U.S. Cl. CPC H04L 9/0662; H04L 9/0869

(57) ABSTRACT

The present innovative solution increases security to interceptor attacks while not significantly minimizing the processing resource and time requirements of cryptography processes that are used. A novel RPC is used in conjunction with a public key, used to create private keys, for scrambling ASCII dictionary strings, which are then used to calculate distances among characters in the scrambled dictionary. The end result of the encryption process is not a ciphertext string but, instead, it is a string of character distances that any interceptor cannot use since he cannot recreate the scrambled dictionary or deduce what distances represent. The encryption process is simplified by converting computationally intensive operations into simple lookup operations in position strings calculated once for each scrambled dictionary. During decryption the scrambled dictionary and the matching position string are recreated and the original plaintext is recovered by simple lookup operations.

### BACKGROUND

### Field

The present invention relates to data encryption based on random position ciphers and operating on scrambled ASCII strings.

### Background

Cryptography is an interdisciplinary field of study, development and use of encryption and decryption techniques for the purpose of concealing the content of messages. It is defined as the system by which data and information of value are stored or transmitted in such a way that only those for whom data are intended can read, interpret or process them. Effectively, cryptography obscures information from unauthorized snoopers and interceptors. In the same way, cryptography can be used to hide dubious and clandestine activities in our modern cyber world today. Cryptography refers to the design of mechanisms based on mathematical algorithms that provide fundamental information security services. PRNGs (Pseudo-Random Number Generators) are also used in cryptography where the seed is kept secret so as to prevent hackers from calculating the next numbers in the sequence of pseudo-random numbers produced by the generator.

Three main categories of cryptography methods and systems are known in prior art:
public-key cryptography
secret-key cryptography
hash functions

In public-key cryptography the encryption-decryption key is openly available to any person or system. Hash functions are secret functions or tables used to lookup substitutions of original input data characters to new characters used for encrypting the data and for subsequent decryption. They are very easy and fast to use and only need to be created once. However, they can be stolen or calculated by an interceptor, usually with limited processing and experimentation.

Secret-key cryptography is the category of choice where high levels of security are needed, as in banking, military, and other critical applications. Secret-key cryptography works on the assumption that the encryption and decryption keys are kept secret from all but the sender and receiver and is subdivided into block cipher and stream cipher.

In block cipher the input data stream is broken into blocks of length equal to the secret key and is encoded and decoded in parts according to the blocks. As a result, smaller keys can be used for ease of key creation, and simplification and speed of the calculations involved in the encoding and decoding operations.

In stream cipher methods, long secret keys are constructed, matching the length of the input text. Despite the heavier processing involved by stream ciphers, the methods using stream ciphers are more secure as the key is not repeated (as with block ciphers) and is more difficult to be guestimated by an interceptor. This extra security at the cost of speed is a very important concern for applications and systems where very fast response is needed (e.g. in real time applications like streaming), where low processing power is available (e.g. mobile and Internet-of-Things devices), and where low power operation is needed so as not to deplete battery power fast. These constraints are in opposition with high security, which is becoming a very serious concern as very fast computers are increasingly available in routine use and can be employed in breaking the encryption used in any security application where encryption is used. This problem is expected to further aggravate with the forthcoming availability of quantum computers where extreme processing power is expected to become available and thus be potentially used for breaking encryption algorithms and keys.

There is therefore a pressing need for a novel encryption/decryption algorithm and system that can offer very highly secure encryption/decryption while being suitable for low-power, low-processing power, low-processing time systems and capable of withstanding attacks of quantum computers. Such an algorithm and system should be capable to outperform the AES-256 algorithm which is currently considered as the most secure encryption/decryption algorithm.

### SUMMARY

The present innovative solution solves the problem of finding an encryption/decryption algorithm and system that can offer very highly secure encryption/decryption while being suitable for low-power, low-processing power, low-processing time systems and capable of withstanding attacks of quantum computers at the same time.

In a first exemplary implementation, a sender creates a public key and uses it to create a private key, which it uses as a seed number to a Pseudo Random Number Generator (PRNG) that produces a set of 256 Pseudo Random Numbers (PRN) each having a very large number of digits. In one aspect, the private key and the PRNs each have 256 or up to 2048 bits. The PRNs are used to produce PRNs in the range of (0 . . . 256), which are associated with the cells of a string containing the 256 standard ASCII codes. The string containing the ASCII codes is scrambled using the associated PRNs and fed to an encrypter which creates a ciphertext string from an input plaintext string. Instead of transmitting the ciphertext, a distancetext string is created and transmitted to a receiver. The distancetext is created by looking the distance between characters in the scrambled ASCII string matching the characters in the ciphertext. By transmitting only the distancetext and the public key, a receiver can create its own private key and follow the same process to scramble the standard ASCII string and use it together with the characters in the distancetext string to recreate the original plaintext string. The scrambled ASCII string is treated as a cyclic string.

In a second exemplary embodiment, the sender and the receiver create the scrambled ASCII string in the same way described for the first embodiment and add an additional step of swapping the character values between a current and a previous character in the scrambled ASCII string, where the current and a previous character are separated by a distance from the distancetext string.

The present solution is in effect a new category of cryptography methodologies, as it does not substitute a plaintext symbol with a ciphertext symbol as done by known cryptography algorithms in the prior art. Instead, the present solution represents each plaintext character with a string of distances and share the same public key between a sender and a receiver. An interceptor can only access the distancetext (and maybe not even the public key as it is optionally sent over a different communications channel or session). As a result, the interceptor cannot recreate the original plaintext, as he is neither in a position to recreate the scrambled ASCII string, nor can he interpret and do any known cryptanalytic attack in the meaning of the distancetext string.

The distancetext is not necessarily a string of random numbers. It is the secret of the meaning of the distances in the distancetext string, and the absence of knowledge about the ciphertext and the construction of the scrambled ASCII string that makes the present innovative solution strong and resistant against interceptor attacks. The scrambled ASCII dictionary is hard to produce as each of the distances in the distancetext may be associated with any of 256×256=65536 possible character combinations.

Encryption is based on the size of the scrambled dictionary. In one aspect where the scrambled ASCII string (i.e. the dictionary) is 256=2⁸ characters long, encryption of the plaintext is done on 8-bits per encryption processing cycle. This is the standard dictionary. In alternative exemplary embodiments, the dictionary may be of any length small or larger than 256, as long as its length is a power of 2. For example, larger dictionaries can be used to encrypt plaintext on a large number of bits that 8, with a higher speed of encryption. This does not have any negative implications on the speed of the encryption.

For encrypting 8 bits per encryption cycle, the size of the dictionary is 2⁸×8 bits=256×8 bits=2048 bits in the memory used by the encryption processor. The processing speed may be seen in FIG. 12. It is approximately 245 times faster than the speed of AES 256.

For 64-bit processors, encrypting 64-bits of plaintext at a time is the optimal choice for the higher encryption speed for 64-bit processors. Similarly, for other types of processors (other than 64-bit processors) a different choice of different bit encryption may be chosen to match the type of processor used (e.g. encrypting 32 bits for 32-bit processors, encrypting 128 bits for 128-bit processors, etc.).

For encrypting 32 bits per encryption cycle, the size of the dictionary is 2³²×32 bits=4294967296×32 bits=137,438,953,472 byte=137.4 GB in the memory used by the encryption processor. The processing speed may be seen in FIG. 12. It is approximately 980 times faster than the speed of AES 256.

This huge encryption speed increase relative to AES-256 and other known algorithms may be further significantly increased if the present innovative solution is executed in parallel hardware architectures, and especially parallel computing based on Graphics Processing Units (GPUs). The parallel computing may be implemented by parallel processors of parallel GPUs, or with processors or GPUs with multiple cores.

The encryption speed increase due to the size of the dictionary is applicable to both exemplary implementations. This encryption speed increase due to parallel processing is only applicable to the first exemplary implementation and not to the second exemplary implementation (i.e. not for swapping dictionary values).

### BRIEF DESCRIPTION OF THE DRAWINGS

FIG. 1 shows a high-level software architecture of the present innovative encryption-decryption exemplary solution.

FIG. 2 shows a high-level flowchart of the proposed encryption solution according to a first exemplary implementation.

FIG. 3 shows a mid-level flowchart of the proposed encryption solution using a static scrambled ASCII dictionary according to a first exemplary implementation.

FIG. 4 shows a low-level flowchart of the proposed encryption solution using a static scrambled ASCII dictionary according to a first exemplary implementation.

FIG. 5 shows an example calculation of distances according to the first exemplary implementation.

FIG. 6 shows how an example position lookup string is constructed from the static scrambled ASCII dictionary according to the first exemplary implementation.

FIG. 7 shows mid-level flowchart of the proposed decryption solution using the static scrambled ASCII dictionary according to the first exemplary implementation.

FIG. 8 shows a low-level flowchart of the proposed encryption solution using a dynamic scrambled ASCII dictionary according to a second exemplary implementation.

FIG. 9 shows an example calculation of distances according to the second exemplary implementation.

FIG. 10 shows a low-level flowchart of the proposed decryption solution using a dynamic scrambled ASCII dictionary according to a second exemplary implementation.

FIG. 11A shows an exemplary high-level hardware architecture of an encryption module according to the present innovative encryption exemplary solution.

FIG. 11B shows an exemplary high-level hardware architecture of a decryption module according to the present innovative decryption exemplary solution.

FIG. 12 shows an example chart comparing the performance of the present innovative solution with the AES-256 algorithm.

### DETAILED DESCRIPTION

The word “exemplary” is used herein to mean “serving as an example, instance, or illustration”. Any embodiment described herein as “exemplary” is not necessarily to be construed as preferred or advantageous over other embodiments.

The acronym “AES” is intended to mean “Advanced Encryption Standard”.

The acronym “ASCII” is intended to mean “American Standard Code for Information Interchange”.

The acronym “CD” is intended to mean “Compact Disc”.

The acronym “DSL” is intended to mean “Digital Subscriber Line”.

The acronym “DVD” is intended to mean “Digital Versatile Disc”.

The acronym “IoT” is intended to mean “Internet of Things”.

The acronym “NFC” is intended to mean “Near-Field Communication”.

The acronym “PRN” is intended to mean “Pseudo-Random Number”.

The acronym “RPC” is intended to mean “Random Position Cipher”.

The acronym “PRNG” is intended to mean “Pseudo-Random Number Generator”.

The acronym “RNG” is intended to mean “Random Number Generator”.

The acronym “TCP/IP” is intended to mean “Transmission Control Protocol/Internet Protocol”.

The acronym “VPN” is intended to mean “Virtual Private Network”.

The acronym “XOR” is intended to mean “eXclusive OR”.

The acronym “XML” is intended to mean “eXtensible Markup Language”.

The term “mobile device” may be used interchangeably with “client device” and “device with wireless capabilities”.

The term “user” may be used interchangeably with “regular user”, “ordinary user”, and “client”. It may also be used to mean “user of an application” or “user of a service”.

The term “system” may be used interchangeably with “device”, “computing device”, “apparatus”, “computing apparatus”, and “service”, except where it is understood to a reader of ordinary skill in related art that these terms refer to different things, as this is apparent by the context of the discussion in which they appear. Under any circumstance, and unless otherwise explicitly stated or implicitly hinted at in the description, these four terms should be considered to have the broadest meaning i.e. that of encompassing all four.

The term “module” may be used interchangeably with “unit” or “subunit”, except where it is understood to a reader of ordinary skill in related art that these terms refer to different things, as this is apparent by the context of the discussion in which they appear.

The term “big” may be used interchangeably with “large”, except where it is understood to a reader of ordinary skill in related art that these terms refer to different things, as this is apparent by the context of the discussion in which they appear.

Parameters and names in lower-case and upper-case characters are intended to mean the same thing except where it is understood to a reader of ordinary skill in related art that these terms refer to different things, as this is apparent by the context of the discussion in which they appear, or where a different meaning is disclosed in the following description.

The term “string” may be used interchangeably with “stream” and “array”, except where it is understood to a reader of ordinary skill in related art that these terms refer to different things, as this is apparent by the context of the discussion in which they appear.

The term “encoder” may be used interchangeably with “encrypter” and “sender”, except where it is understood to a reader of ordinary skill in related art that these terms refer to different things, as this is apparent by the context of the discussion in which they appear.

The term “decoder” may be used interchangeably with “decrypter” and “receiver”, except where it is understood to a reader of ordinary skill in related art that these terms refer to different things, as this is apparent by the context of the discussion in which they appear.

### Definitions

Plaintext is the data to be protected during transmission.

Encryption Algorithm is a mathematical process that produces a ciphertext or a distancetext for any given plaintext and encryption key. The encryption algorithm is a cryptographic algorithm that takes plaintext and an encryption key as input and produces a ciphertext.

Ciphertext is the different version of the plaintext produced by the encryption algorithm using a specific encryption key. The ciphertext is not guarded and may be transmitted on a public channel. The ciphertext may be intercepted or compromised by anyone who has access to the communication channel.

Distancetext is the version of the plaintext that is produced when the plaintext is encrypted so as to replace its encrypted characters by the distance of the same character from the previous character in the dictionary which is XORed with the plaintext character, and this distance is measured as the distance in characters in a scrambled American Standard Code for Information Interchange (ASCII) string between the positions of these same characters in the ASCII string.

Decryption Algorithm is a mathematical process that produces a unique plaintext for any given ciphertext and decryption key, or for any given distancetext and decryption key. The decryption algorithm is a cryptographic algorithm that takes a ciphertext or a distancetext and a decryption key as input, and outputs a plaintext. The decryption algorithm essentially reverses the encryption algorithm and is, thus, closely related to it.

Encryption Key is a value that is known to the sender. The sender inputs the encryption key into the encryption algorithm along with the plaintext in order to compute the ciphertext.

Decryption Key is a value that is known to the receiver. The decryption key is related to the encryption key but is not always identical to it. The receiver inputs the decryption key into the decryption algorithm along with the ciphertext in order to compute the plaintext.

Private Key is a value known only to its owner or creator.

Public Key is a value known to more entities than its owner or creator.

Technical Characteristics of Encryption Methodologies in the Prior Art

Typically, in a cryptography system, a sender wants to securely transmit input data (e.g. plain text, or any other type of data) over a communications channel (or via a storage medium) to a receiver. Input data are fed at the sender's side to an encryption module (or algorithm) together with an encryption key. Encryption module applies a methodology and encryption key to input data to produce a ciphertext (i.e. encrypted) data. Ciphertext is received by receiver and fed to a decryption module (or algorithm) together with a decryption key. Decryption module outputs plaintext (i.e. decrypted) data, which is intended to be identical to the input plaintext data.

Malicious interceptors may intercept ciphertext at any time after transmission from the sender and before or after reception by the receiver. For an interceptor to make use of ciphertext (or distancetext on the present exemplary implementation), the interceptor has to find a way to substitute the elements (i.e. the characters) in the ciphertext (or distancetext) with characters matching the elements (i.e. the characters) in plaintext. In other words, the interceptor needs to guestimate or steal the decryption key (and also information on what the distancetext represents). Decryption key may be done with a different decryption key or with the same encryption key.

Today with the use of supercomputers or parallel computing it is becoming more likely that an interceptor can “break” an encryption algorithm and manage to decrypt and cyphertext. Security experts continuously try to come up with improved algorithms that rely on very long keys and other methods in order to make them harder to break. However, this never-ending race is getting into dire straits with the forthcoming availability of quantum computers, which will offer huge amounts of processing power that is expected to make existing encryption algorithms vulnerable to interceptors.

Technical Characteristics of the Present Innovative Random Position Cipher (RPC) Encryption/Decryption Methodology Using Static Scrambled ASCII Dictionaries

Encryption

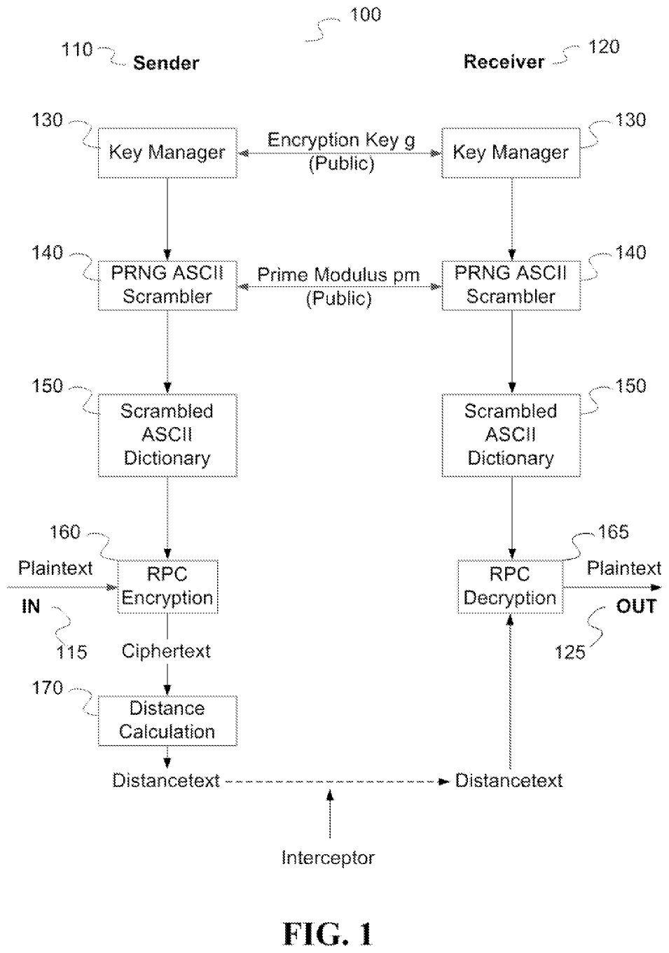

FIG. 1 shows a high-level logical software architecture of the present innovative encryption-decryption exemplary solution. Diagram 100 shows a sender 110 that encrypts a plaintext 115, and a receiver 120 that recreates the same plaintext. Both sender 110 and receiver 120 each have a key manager 130, which agree to a public encryption key g and which both use in the encryption/decryption process. Both sender 110 and receiver 120 each have a Pseudo Random Number Generator (PRNG) ASCII scrambler 150, which uses the public key g to create a private key (a for sender 110 and b for receiver 120), which is kept secret, and a prime modulus pm, which is public and agreed between the two scramblers 150. In one aspect, the prime modulus pm does not need to be shared since it is prearranged, known, and does not vary.

Each scrambler 150 uses the respective private key (a, b) and the common public prime modules pm to scramble a public ASCII string, which contains an ordered listing of the main ASCII codes (i.e. 0 . . . 255). The resulting scrambled dictionary (it is identical for both sender 110 and receiver 120) contains the same ASCII codes (i.e. 0 . . . 255) but in a pseudo random order that is not known to any party not in possession of any of the private keys a, b. The private keys may be produced by any known cryptography algorithm (e.g. RSA, Diffie Hellman, . . . ) using any known PRNG to produce PRN seeds that are used as public key g and optionally as prime modulus pm. The private key (256 up to 2048 bits for the standard 256-character dictionary) is used as a seed to a PRNG to produce RNGs that are converter to lie in the range (0 . . . 255) and which are used for scrambling the standard ASCII codes.

Sender 110 feeds the scrambled ASCII dictionary and a plaintext 115 (that is to be encrypted) to a Random Position Cipher (RPC) encryption algorithm 160, which algorithm produces a ciphertext. In contrast to what is known in prior art, the ciphertext is not transmitted to receiver 120 and is exclusively stored at sender 110, e.g. in secure volatile or non-volatile storage (e.g. memory in combination with a secure kernel, a sandbox, or other secure storage technology).

The ciphertext is used to calculate a distancetext 170 using the scrambled ASCII dictionary. It is this distancetext that is transmitted to receiver 120, and it is only the distancetext (and the public key g, and optionally prime modulus pm) that are susceptible to attacks by interceptors. However, even if an interceptor manager to get access to the distancetext, it is not possible to make sense of its distances, as he cannot reproduce the scrambled ASCII dictionary. It is noted that the public key g, and the prime modulus pm are not sent to receiver 120 together with the distancetext, so as to make it more difficult for an interceptor to steal them all, while in alternative exemplary implementations, different channels (i.e. data networks) may be used, and additional encryption of the public key g, and prime modulus pm may be applied for added security.

Upon reception of the distancetext, receiver 120 feeds the distance text and the scrambled ASCII dictionary (which it has previously produced) to RPC decryption algorithm 165 and produces plaintext 125, which is identical to the plaintext produced by sender 110 using its RPC encryption algorithm 160 and distance calculation 170.

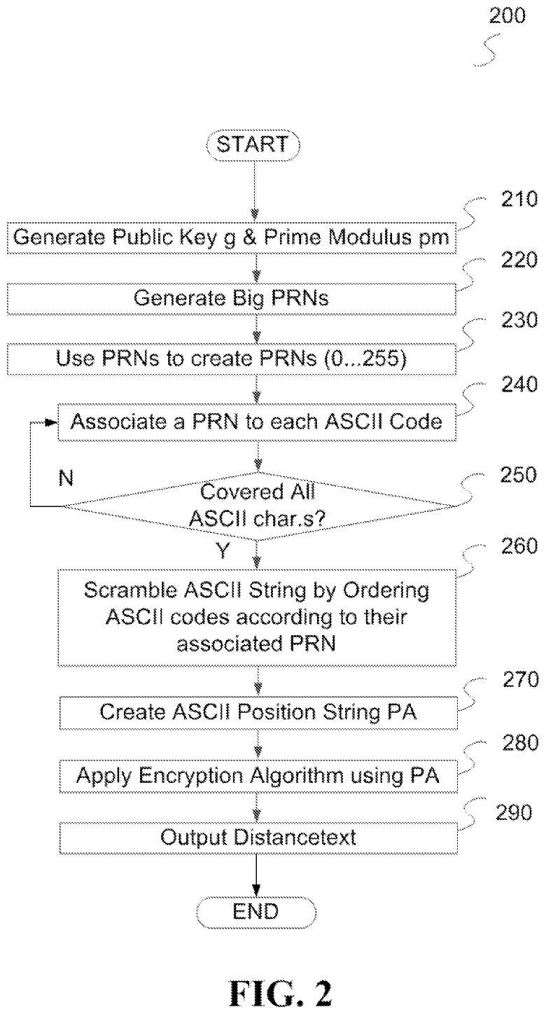

FIG. 2 shows a high-level flowchart of the proposed encryption solution according to a first exemplary implementation. Methodology 200 starts with key manager 130 generating a public encryption key g, which is also sent to receiver 120.

Key manager 130 uses the public key g to produce a private key b and sends the private key b to a PRNG, which uses b as a seed and produces one or more big Pseudo Random Number(s) (PRN) 220, each of which contains any number of digits (e.g. in one aspect PRNs have several hundred or several thousand digits, while in another aspect each of the 256 PRNs has 256 bits or up to 2048 bits). In one aspect the PRNG is part of key manager 130, or in another aspect the PRNG is part of a PRNG ASCII Scrambler 140, or other module).

The PRNs are then used (in one aspect by key manager 130, or in another aspect by PRNG ASCII Scrambler 140) to create a set of small PRNs (256 in this example) in the range (0 . . . 255) 230 by applying a mod 256 operation to each PRN, where 256 is the prime modulus pm, which is sent to receiver 120, as is the public key g. In one aspect a single PRN is used, while in another aspect more than one PRNs are used to produce the set of 256 small PRNs using the mod 256. The outcome of the mod operation are PRNs that are limited in the range (0 . . . 256).

PRNG ASCII Scrambler 140 associates one small PRN (0 . . . 255) with one standard ASCII code 240 ((0 . . . 256) ordered in ascending order). For instance, “123” may be associated to ASCII code “034”, etc. The association is repeated until 250 all ASCII codes have been associated with a PRN. Then PRNG ASCII Scrambler 140 scrambles the standard ASCII string 260, using the small PRNs associated with the ordered standard ASCII codes, so that the position of the ASCII codes in the resulting scrambled ASCII string is random as opposed to the ordered (in increasing order) ASCII string. The resulting scrambled ASCII string is used as a dictionary in the encryption process (also for the decryption process).

In one aspect, the scrambling of the standard ASCII codes is implemented by reading the first PRN r₁=150, and we use r₁ as a pointer to the 150^{th} cell of the standard ASCII codes that are stored in a standard ASCII string, and then swap the 1^{st} value with the 150^{th} value in the standard ASCII codes string. Then we read the second PRN r₂=73, and use it as a pointer to the 73^{rd} cell of the standard ASCII codes and swap the 2^{nd} value with the 73^{rd} value in the standard ASCII codes string. The process is repeated for all 256 PRNs.

The scrambled ASCII string is ready to be used for encrypting plaintext. In one aspect, the encryption speed is boosted by reducing the number of calculations needed. Instead of the encrypter searching and counting the position inside the position of a number inside the scrambled ASCII code, the encryptor simply uses the content of a cell in the scrambled ASCII string W, as a position pointer to a position string PA 270, that the encryptor (i.e. a position calculator) calculates once for the encryption of the entire plaintext using the same public key. As a result, and by means of example, the value “9” of the 1^{st} cell of W points to the 9^{th} cell of position string PA, which contains the value “1”, corresponding to the first cell (i.e. position) in the scrambled ASCII string W.

The encryption algorithm is applied 280 to the plaintext, using the position string PA position string PA for replacing complex computations with a simple lookup operation in PA. The encryption algorithm thereby creates a distancetext 290 receiver 120.

In another exemplary implementation, the 256 standard ASCII codes and the mod 256 operation may be substituted by any number of codes and modulus. For example, less than 256 codes and modulus could be used), or more than 256 codes and modulus could be used. However, for more than 256 codes and modulus, the clever substitution of complex operations with simple lookup operations results in only minimal negative impact to the calculations for the encryption (and decryption) of plaintext.

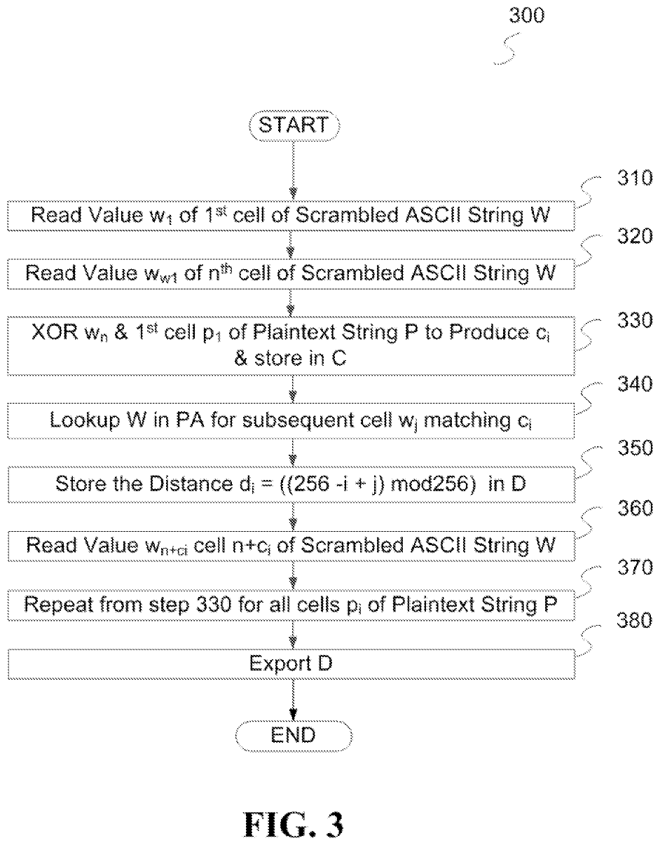

FIG. 3 shows a mid-level flowchart of the proposed encryption solution using a static scrambled ASCII dictionary according to a first exemplary implementation. Encryption methodology 300 starts with the encryptor reading the value in the first cell of the scrambled ASCII string W 310, e.g. it reads value “19”, and using this value as the an index (or pointer) to the e.g. 19^{th} cell in W, and reads the value in the 19^{th} cell of W 320. The encryptor then calculates (w₁₉ XOR p₁), where p₁ is the first character in the plaintext P, to produce a cipher character cᵢ which it stores in the first cell of a ciphertext string C 330. Operation 330 (w₁₉ XOR p₁)=(25 XOR 99)=122 in our example. The encryptor then reads the value in the 122^{nd} cell of PA 340 (which is equal to 56), uses this value as the value of “j”, i=19 and calculates dᵢ=((256-19+56) mod 256)=37, and stores dᵢ in D 350.

Methodology 300 continues by reading the value w_{19+c}_{ᵢ}=w₁₉₊₁₂₂=w₁₄₁ 360 and the steps 330 onwards are repeated until all characters of the plaintext P have been encrypted and the corresponding distances have been stored in D. D is then exported (i.e. sent to the receiver and/or saved at a secures storage location in the sender).

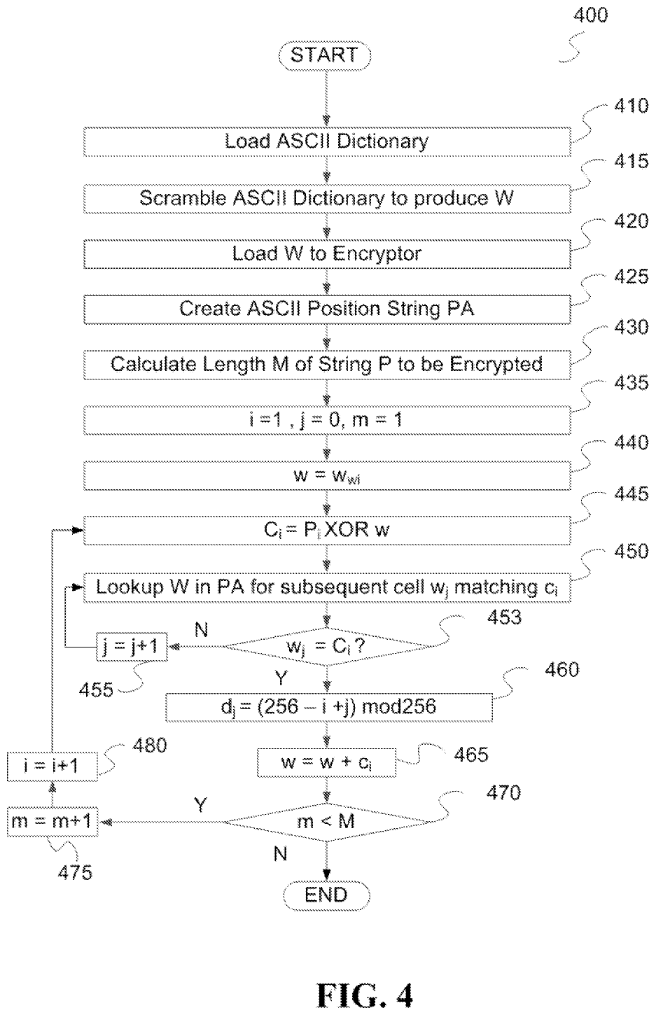

FIG. 4 shows a low-level flowchart of the proposed encryption solution using a static scrambled ASCII dictionary according to a first exemplary implementation. Methodology 400 starts with PRNG ASCII scrambler 140 loading the standard ASCII dictionary in a standard ASCII string 410 and scrambling 415 the standard ASCII string using the 256 short (0 . . . 255) PRNs produced by the PRNG with the private key (that is produced using the public key agreed between the sender and receiver, using any known key algorithm) as seed.

The encryptor loads the scrambled ASCII dictionary W 420, creates ASCII position String PA 425, calculates the length M if the plaintext string P, that is to be encrypted and sets variables i equal to 1, j equal to 0, and m equal to 1, and sets the current scrambled ASCII dictionary character w 440 equal to the value in the cell with the position in W equal to the value of the previous current scrambled ASCII dictionary character w, which for the first application of step 440, is the first cell in W.

The encryptor then calculates the corresponding distance (cᵢ=pᵢ XOR w) 445 by looking-up the distance in the position string PA 450 and increases variable j by 1 455 and repeats step 540 until the value of wⱼ equals cᵢ 453, and then calculates the distance (dⱼ=(256−i+j) mod 256) 460 and sets w=w+cᵢ 465. If m<M, methodology 400 increases m 475 and i 480 by 1 and branches back to step 445. Once m=>M 470 methodology 400 ends as the encryption of plaintext P is completed and distance string D has been created and set.

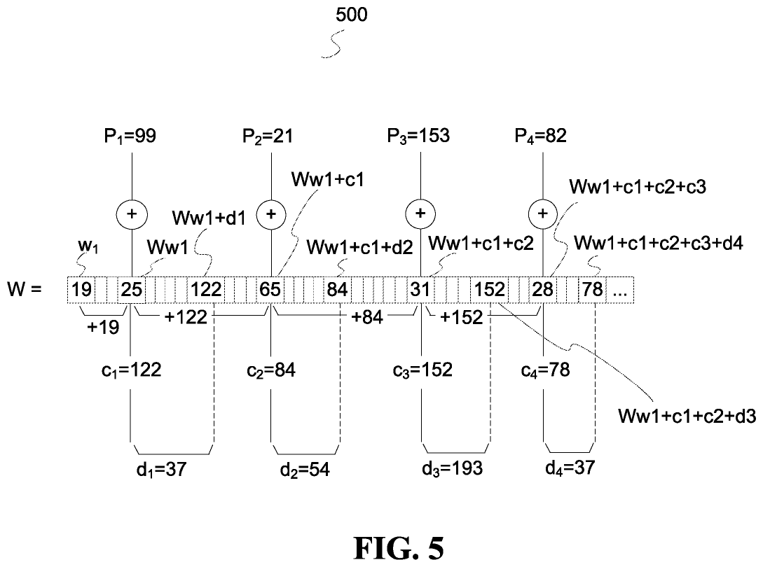

FIG. 5 shows an example calculation of distances according to the first exemplary implementation. Example 500 contains scrambled ASCII string W, with a first cell w₁=19. The encryptor reads w₁=19 and uses the value “19” as an index pointing to the 19^{th} cell w₁₉=25.

It then calculates (w₁₉ XOR p₁)=(25 XOR 99)=122, thereby creating the first ciphertext character c₁=122, which effectively encrypts the first plaintext character p₁. The encryptor looks for the next cell in W, which contains the value of c₁=122. This value is in the d₁=37^{th} cell of W after w₁₉, i.e. in cell w₁₉₊₃₇=w₅₆ from the beginning of W. The ciphertext C is not sent to the receiver, and there is no need to store it at the sender, as it is no longer used in the encryption of plaintext P.

The encryptor loads the cell that is c₁=122 positions (i.e. cells) after w₁₉, i.e. w₂₅₊₁₂₂=w₁₄₇=65 and encrypts the second plaintext character p₂ by (w₁₄₇ XOR p₂)=(65 XOR 21)=84=c₂. The encryptor looks for the next cell in W, which contains the value of c₂=84. This value is in the d₂=54^{th} cell of W after w₁₉, i.e. in cell w₁₉₊₃₇₊₅₄=w₁₁₀ from the beginning of W. The ciphertext C is not sent to the receiver, and there is no need to store it at the sender, as it is no longer used in the encryption of plaintext P.

The encryptor loads the cell that is c₂=84 positions (i.e. cells) after w₁₉₊₁₂₂, i.e. w₁₄₁₊₈₄=w₂₂₅=31 and encrypts the third plaintext character p₃ by (w₂₂₅ XOR p₃)=(31 XOR 153)=152=c₃. The encryptor looks for the next cell in W, which contains the value of c₃=152. This value is in the d₃=193^{rd} cell of after w, i.e. in cell w₂₂₅₊₁₉₃=w₄₁₈ from the beginning of W. The ciphertext C is not sent to the receiver, and there is no need to store it at the sender, as it is no longer used in the encryption of plaintext P.

The encryptor loads the cell that is c₃=152 positions (i.e. cells) after w₂₂₅, i.e. w₂₂₅₊₁₅₂=w₃₇₇=28 and encrypts the third plaintext character p₄ by (w₃₇₇ XOR p₄)=(28 XOR 82)=78=c₄. The encryptor looks for the next cell in W, which contains the value of c₄=78. This value is in the d₄=37^{th} cell of W after w, i.e. in cell w₃₇₇₊₃₇=w₄₁₄ from the beginning of W. The ciphertext C is not sent to the receiver, and there is no need to store it at the sender, as it is no longer used in the encryption of plaintext P.

The calculation of distances is done using the formula: di=(256−i+j) mod 256, which effectively treats the scrambled ASCII string as a cyclic string. “i” is the current cell in the scrambled ASCII string, and “j” is the position taken from the PA string.

Encryption continues until all characters of plaintext P have been encrypted and all the corresponding distances dᵢ have been calculated and saved in D. D is then securely saved in the sender and send to receiver.

In the above calculations it is noted that W has 256 cells, so for cells with positions above 256, the respective positions above 256 are calculated again from the 1^{st} position, effectively treating Was a cyclic array.

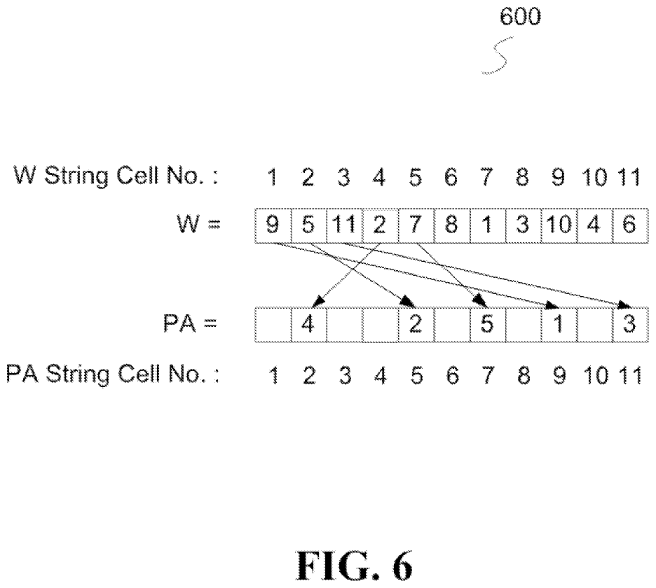

FIG. 6 shows how an example position lookup string is constructed from the static scrambled ASCII dictionary according to the first exemplary implementation. Example 600 contains scrambled ASCII string W. For reasons of simplicity, only the first 11 cells of W are shown, containing (from the 1^{st} to the 11^{th} cell) values 9, 5, 11, 2, 7, 8, 1, 3, 10, 4, and 6.

Together with W is shown position string PA, with the same number of cells as W. PA is constructed by taking, in turn, each cell of W, reading its value and using the value as a pointer to a cell position in PA, and filling the value of the pointed cell in PA with the position of the said cell in W. For example, the 1^{st} cell in W contains the value “9” which is used as a pointer to the 9^{th} cell in PA; the 9^{th} cell in PA is set to the value “9” of the first cell of W. Similarly, the 2^{nd} cell of W is used to set the 5^{th} cell of PA to the value “2”, and so on for the remaining cells.

As a result, the string PA is populated with all values matching the cell positions in W and in the positions pointed to by the values in the corresponding cells of W (not all are shown in FIG. 6).

Decryption

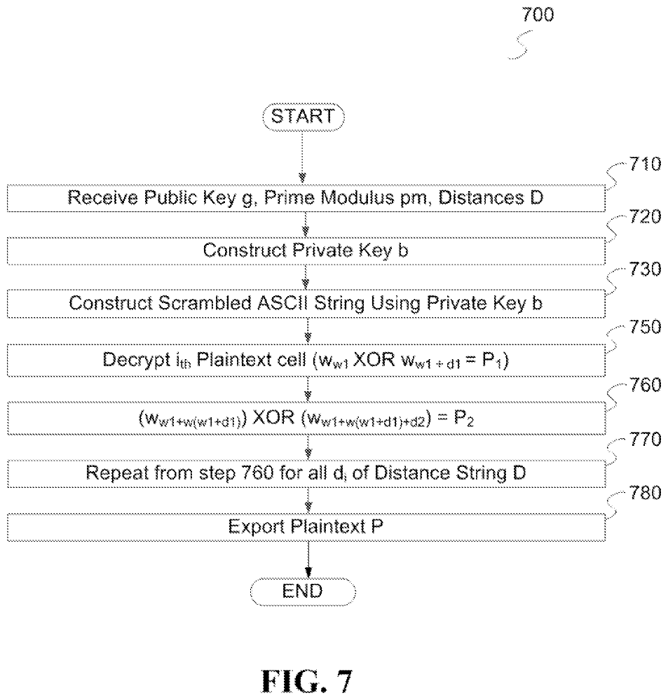

FIG. 7 shows mid-level flowchart of the proposed decryption solution using the static scrambled ASCII dictionary according to the first exemplary implementation. Methodology 700 starts with the receiver receiving 710 from the sender a public key g, and a prime module pm. The receiver (i.e. a decryption processor) also receives from the sender a distancetext string D. In one aspect D is received at a separate transmission and optionally via a separate network than for g and pm for added security. The receiver constructs a private key b 720 and uses b to construct a scrambled ASCII string 730, which is identical to the scrambled ASCII string the sender constructed for encrypting the original plaintext. Decryption is done as an XOR operation between the value of the cell whose position is pointed to by the value in the first position of the scrambled ASCII string W 750. For the first calculation 750, the 1^{st} plaintext character is calculated as (w_{w1} XOR w_{w1}+d₁=P₁). The calculation of the second plaintext character 760 is done by calculating (w_{w1+w(w1+d1)}) XOR (w_{w1+w(w1+d1)+d2)})=P₂. Step 760 is repeated 770 until all characters in the distance string D have been converted into plaintext P characters, and P is exported 780 (e.g. saved, displayed, or otherwise used at the receiver). In every iteration of step 760, the formula is computed by updating the to the indices of the w cell an extra distance dᵢ.

Technical Characteristics of the Present Innovative Random Position Cipher (RPC) Encryption/Decryption Methodology Using Dynamic Scrambled ASCII Dictionaries

Encryption

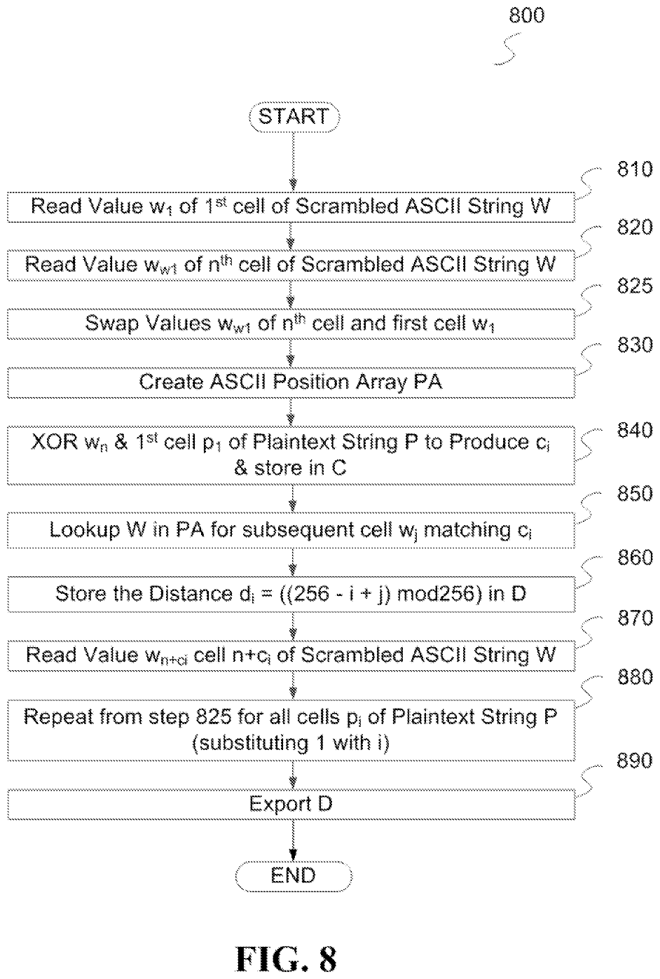

FIG. 8 shows a low-level flowchart the proposed encryption solution using a dynamic scrambled ASCII dictionary according to a second exemplary implementation. Methodology 800 starts with the encryptor reading the value of the first cell of the scrambled ASCII string W 810, which has been constructed identically to the construction of the scrambled ASCII string W in the first exemplary embodiment where a static dictionary is used. The encryptor continues by reading the value of the cell (for simplicity we refer to it as the second cell) pointed to by the value of the first cell in W 820 and swapping values between the first and second cells of W 825.

The encryptor creates the ASCII position array PA 830 exactly like the process described in the first exemplary embodiment where a static dictionary is used. Step 830 is, in another aspect, performed prior to step 810. The first ciphertext character cᵢ is calculated 840 as an XOR operation between the value of the second cell of W and the first cell of the plaintext string P. The operation is implemented as a lookup of W in PA to find the value of C 850 and the distance d₁ is calculated 860 in the same way as in the first embodiment, i.e. dᵢ=((256−i+j) mod 256) and stored in D.

The encryptor then reads the value of the cell calculated by adding to the position of the second cell the value of the ciphertext character cᵢ 870 and repeats the process from step 825 and for all cells in the plaintext string.

Methodology 800 is identical to the encryption methodology used in the first exemplary embodiment. The only exception is that methodology 800, swaps the values of W, in step 825 thus introducing the use of dynamic scrambled ASCII tables W.

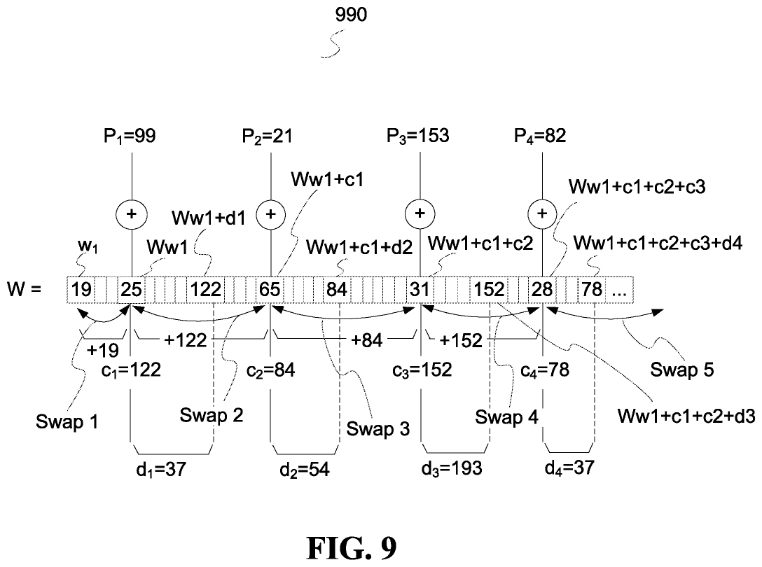

FIG. 9 shows an example calculation of distances according to the second exemplary implementation. Example 990 is identical to example 500, and also includes the swapping of characters in the scrambled ASCII dictionary during the calculations of the distance characters of the distancetext produced by the encrypter.

The swapping of the characters in the scrambled ASCII dictionary is performed one at a time before the respective ciphertext and distancetext character calculations. So, swapping 1 is done before the calculation of ciphertext character c₁ and distancetext character d₁, swapping 2 is done before the calculation of ciphertext character c₂ and distancetext character d₂, swapping 3 is done before the calculation of ciphertext character c₃ and distancetext character d₃, swapping 5 is done before the calculation of ciphertext character c₄ and distancetext character da, and so on for swapping 5 and until the last ciphertext and distancetext characters have been calculated.

Decryption

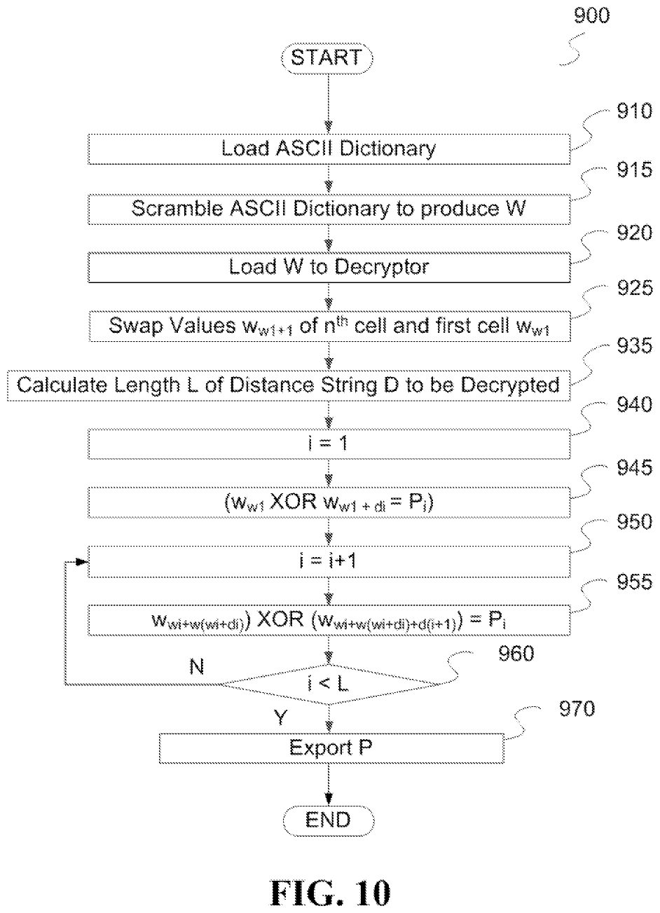

FIG. 10 shows a low-level flowchart the proposed decryption solution using a dynamic scrambled ASCII dictionary according to a second exemplary implementation. Methodology 900 starts with the decryptor loading the ACSII dictionary string 910 and scrambling the dictionary to produce the scrambled ASCII dictionary W 915, which has been constructed identically to the construction of the scrambled ASCII string W in the first exemplary embodiment where a static dictionary is used. The decryptor loads W 920 and swaps the value of the first cell with the value of the cell whose position is pointed by the value of the first cell 925.

The decryptor calculates the length L 935 of the distance string D that is has received and which is wants to decrypt, sets variable i=1 940 and calculates the operation (w_{w1} XOR_{ww1+di}=Pi).

The decryptor then increases i by 1 950 and continues with the second plaintext character by calculating (w_{wi+w(wi+di)}) XOR (w_{wi+w(wi+di+d(i+1)}))=Pᵢ) 955, and branching back to step 950 for as long as i<L 960, i.e. for as long as there are still characters in the distancetext string D that have not been used by the decoder to produce the corresponding plaintext characters in string P. When the entire set of characters in the distancetext string D have been used by the decoder to produce the corresponding plaintext characters in string P, P is exported 970 (e.g. saved, displayed, or otherwise used at the receiver).

Methodology 900 is identical to the decryption methodology used in the first exemplary embodiment. The only exception is that methodology 900, swaps the values of W, in step 925 thus introducing the use of dynamic scrambled ASCII tables W.

Hardware Architecture

Encoder

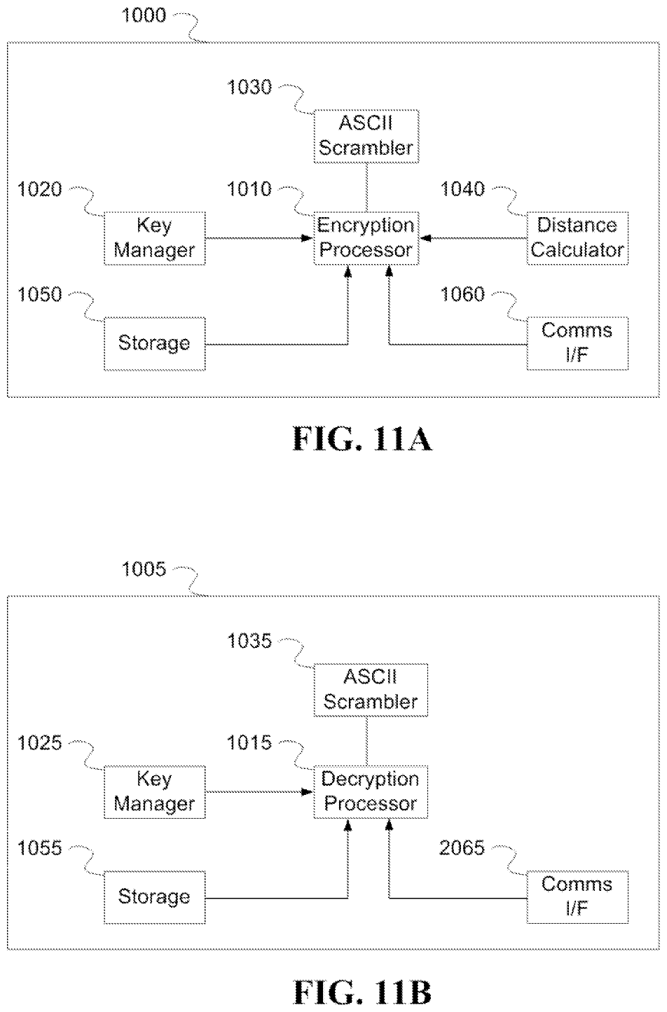

FIG. 11A shows an exemplary high-level hardware architecture of an encryption module according to the present innovative solution. Hardware architecture 1000 may be used for the encrypters (i.e. computing apparatuses, encryption apparatuses, modules, systems, etc.) of both the first and the second exemplary implementations. Encrypter 1000 has an encryption processor 1010 which is the main processing module running software, and which according to the particular exemplary implementation used may be in firmware, executables, etc. and written in any programming language. Encryption processor 1010 communicates with an ASCII scrambler 1030 (which scrambles the standard ASCII string using a private key a produced by the key manager 1020 and using a PRNG), a key manager 1020, a distance calculator 1040 (which calculates distances in the scrambled ASCII string W using the position string PA), an optional storage module 1050 (e.g. some form of volatile or persistent memory or similar module), and an optional communications interface 1060, for communicating with other module and systems.

In one aspect, the software modules of the key manager 130 run on key manager 1020, PRNG ASCII Scrambler 140 and Scrambled ASCII Dictionary 150 run on ASCII scrambler 1030, Distance Calculation 170 runs on distance calculator 1040, and RPC Encryption 160 runs on encryption processor 1010.

In alternative embodiments, the encrypter 1000 may also be implemented with additional modules, or some of its modules be omitted or merged without departing from the scope of protection of the present innovative solution.

Decoder

FIG. 11B shows an exemplary high-level hardware architecture of a decryption module according to the present innovative decryption exemplary solution. Hardware architecture 1005 may be used for the decrypters (i.e. computing apparatuses, decryption apparatuses, modules, systems, etc.) of both the first and the second exemplary implementations. Decrypter 1005 has a decryption processor 1015 which is the main processing module running software, which according to the particular exemplary implementation used may be in firmware, executables, etc. and written in any programming language. Decryption processor 1015 communicates with an ASCII scrambler module 1035 (which scrambles the standard ASCII string using a private key a produced by the key manager 1025 and using a PRNG), a key manager 1025, an optional storage module 1055 (e.g. some form of volatile or persistent memory or similar module), and an optional communications interface 1065, for communicating with other modules and systems.

In one aspect, the software modules of the key manager 130 run on key manager 1025, PRNG ASCII Scrambler 140 and Scrambled ASCII Dictionary 150 run on ASCII scrambler 1035, and RPC Decryption 165 runs on decryption processor 1015.

In alternative embodiments, decrypter 1005 may also be implemented with additional modules, or some of its modules be omitted or merger without departing from the scope of protection of the present innovative solution.

Advantages of the Proposed Innovative Solution

The proposed methodologies, software and hardware architectures offer a variety of advantages over prior art encryption/decryption methodologies and systems. By means of example, and without limit its scope of protection, the present innovative solution is suitable for low-power systems (e.g. portable systems, including mobile payments and credit cards, Near-Field Communication (NFC), Internet-of-Things (IoT), etc.), low processing-power systems (e.g. portable, IoT, and embedded devices, etc.), low-processing-time-response systems (e.g. IoT for autonomous driving, military applications, etc.), real-time 4K video, real-time audio, real-time 8K telemedicine, and real-time movie theater quality super high-resolution video systems, video games, etc.

Apart from the many advantages mentioned above, the present innovative solution offers a far superior security compared to all known encryption/decryption algorithms and systems, including the Advanced Encryption Standard (AES)-256 algorithm.

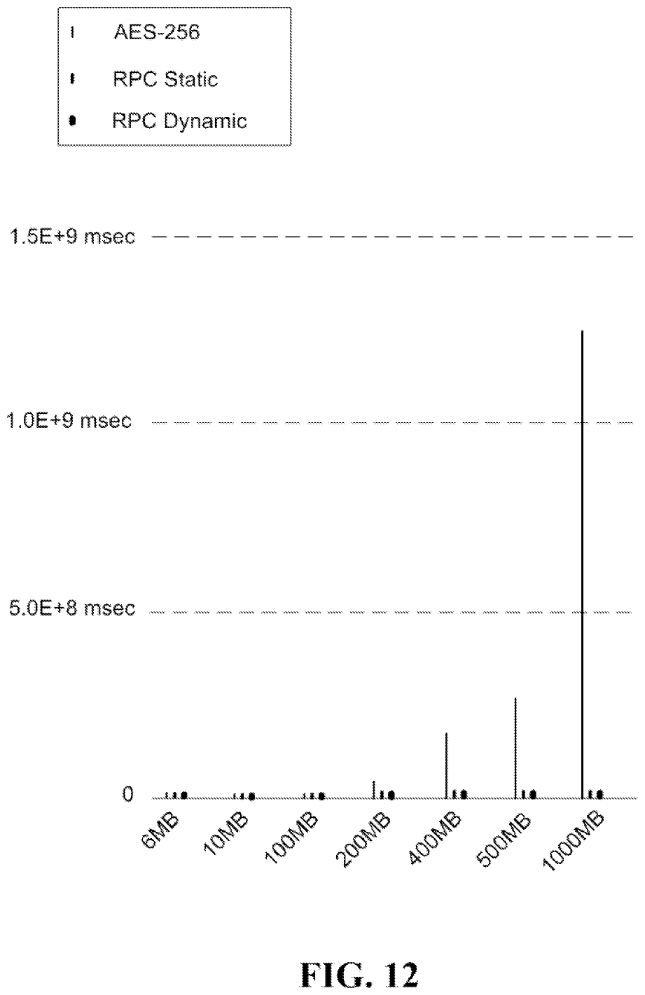

FIG. 12 shows an example chart comparing the performance of the present innovative solution with the AES-256 algorithm. As the size of the data to be encrypted/decrypted increase, the gap in the performance between the AES-256 algorithm and the present innovative solution for the static (standard) and for the dynamic (swapped) scrambled dictionary is huge. For very small data (6-100 MB) the performance of AES-256 is 4 times slower that both the present RPC algorithms, while from 200 MB upwards the AES-256 is significantly slower and for 1000 MB the AES-256 is of the order of (1.25*10⁹) msec slower than both exemplary implementations of the present innovative solution.

Exemplary Use of the Innovative Solution

The present algorithms and hardware modules may be used in a wide variety of applications. By means of example and without limiting the scope of protection of the present innovative solution, possible uses include encryption and decryption of any file type, use in audio and video conferencing, streaming applications, Bluetooth file transfers, NFC, Transmission Control Protocol/Internet Protocol (TCP/IP), Virtual Private Network (VPN) any type of network communication whether wired or wireless, military applications, payment systems and applications, IoT applications and systems, cloud computing, parallel computing, quantum computing, etc.

In the exemplary implementations, the ciphertext is not stored in a string and is not saved so as to ensure higher security. Instead, only the current ciphertext character is stored at a memory location upon its calculation and is overwritten at every new cipher character calculation.

The examples used above to describe the present innovative solution should not be viewed as limiting the scope of the present innovative solution. The present innovative solution may be applied to use scenarios and settings other than those described in the presented examples.

The above exemplary implementations are intended for use either as a standalone system or method in any conceivable scientific and business domain, or as part of other scientific and business methods, processes and systems.

The above exemplary embodiment descriptions are simplified and do not include hardware and software elements that are used in the embodiments but are not part of the current invention, are not needed for the understanding of the embodiments, and are understood to any user of ordinary skill in related art. Furthermore, variations of the described method, system architecture, and software architecture are possible, where, for instance, method steps, and hardware and software elements may be rearranged, omitted, replaced with equivalent, or new added.

Various embodiments of the invention are described above in the Detailed Description. While these descriptions directly describe the above embodiments, it is understood that those skilled in the art may conceive modifications and/or variations to the specific embodiments shown and described herein unless specifically excluded. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or any other device or apparatus operating as a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing apparatus for encrypting plaintext, comprising:
a key manager, configured for (a) creating a public key, (b) using the public key to create a private key, and (c) sending the private key to a Pseudo Random Number Generator (PRNG) for producing at least one big Pseudo Random Number (PRN), and (d) using the at least one big PRN to produce 256 small PRNs in the range of (0 . . . 255) by one of (i) splitting the at least one big PRN to a plurality of smaller PRNs and applying a (mod 256) operation to each of the plurality of smaller PRNs, and (ii) applying a (mod 256) operation to each of the big PRNs;
an American Standard Code for Information Interchange (ASCII) scrambler, configured for (e) associating each of the 256 small PRNs with one of 256 standard ASCII codes ordered in ascending order, and (f) scrambling the order of the standard ASCII codes, using the 256 small PRNs as the positions of the scrambled ASCII codes, to produce a dictionary, wherein the at least one big PRN has between 256 and 2048 bits each for the said dictionary;
a distance calculator, configured for counting the distance between the positions of the scrambled ASCII codes in the dictionary; and
an encryption processor, connected to the key manager, the ASCII scrambler, and the distance calculator, the encryption processor being configured for using the dictionary to encrypt a plaintext data by (g) reading a value of a first character in the dictionary, (h) using the value of the first character in the dictionary as a pointer to a second character in the dictionary, (j) calculating a first ciphertext character as an XOR operation between the value of the second character in the dictionary and a first character in the plaintext, (k) searching the dictionary for a next character in the dictionary with a value equal to the first ciphertext character, (l) using the distance calculator to calculate a first distance as a distance in positions of the second character in the dictionary and the next character in the dictionary, (m) reading a value of a third character in the dictionary by adding the first ciphertext character to the position of the second character in the dictionary, (n) repeating steps (j)-(m) using the value of a new third character in the dictionary calculated at each repetition of step (m) until a distance is calculated for each character in the plaintext data, and (o) exporting a distancetext containing all distances in their order of calculation.

2. The computing apparatus of claim 1, wherein the encryption processor is further configured for (p) swapping the value of the first character in the dictionary with the value of the second character in the dictionary, after the execution of step (h), and (q) swapping the value of the second character in the dictionary with the value of the third character in the dictionary at every repetition of step (n).

3. The computing apparatus of claim 1, wherein steps (k)-(l) are calculated as a look up operation in a position string.

4. The computing apparatus of claim 3, wherein the position string is calculated by (iii) using a value of a character in the dictionary as a pointer to a position in the position string, and (iv) filling a value of the position in the position sting with the position of the character in the dictionary.

5. A computing apparatus for decrypting distancetext, comprising:
a key manager, configured for (a) receiving a public key, (b) using the public key to create a private key, and (c) sending the private key to a Pseudo Random Number Generator (PRNG) for producing at least one big Pseudo Random Number (PRN), and (d) using the at least one big PRN to produce 256 small PRNs in the range of (0 . . . 255) by one of (i) splitting the at least one big PRN to a plurality of smaller PRNs and applying a (mod 256) operation to each of the plurality of smaller PRNs, and (ii) applying a (mod 256) operation to each of the at least one big PRN;
an American Standard Code for Information Interchange (ASCII) scrambler, configured for (e) associating each of the 256 small PRNs with one of 256 standard ASCII codes ordered in ascending order, and (f) scrambling the order of the standard ASCII codes, using the 256 small PRNs as the positions of the scrambled ASCII codes, to produce a dictionary; and
a decryption processor, connected to the key manager, and the ASCII scrambler, the decryption processor being configured for (g) receiving distancetext data, (h) using the dictionary to decrypt a plaintext by (j) reading a value of a first character in the dictionary, (k) using the value of the first character in the dictionary as a pointer to a second character in the dictionary, (l) calculating a first plaintext character as an XOR operation between the value of the second character in the dictionary and a first character in the distancetext data, (m) reading a value of a third character in the dictionary by adding the first character in the distancetext data to the position of the second character in the dictionary, (n) repeating step (l) using the value of a new third character in the dictionary calculated at each repetition of step (m) until a plaintext character is calculated for each character in the distancetext data, and (o) exporting a plaintext containing all plaintext characters in their order of calculation.

6. The computing apparatus of claim 5, further comprising swapping (p) the value of the first character in the dictionary with the value of the second character in the dictionary, after the execution of step (k), and (q) the value of the second character in the dictionary with the value of the third character in the dictionary at every repetition of step (n).

7. A computer implemented method for encrypting plaintext, comprising:
using a key manager, to (a) create a public key, (b) use the public key to create a private key, and (c) send the private key to a Pseudo Random Number Generator (PRNG) for producing at least one big Pseudo Random Number (PRN), and (d) using the at least one big PRN to produce 256 small PRNs in the range of (0 . . . 255) by one of (i) splitting the at least one big PRN to a plurality of smaller PRNs and applying a (mod 256) operation to each of the plurality of smaller PRNs, and (ii) applying a (mod 256) operation to each of the big PRNs;
using an American Standard Code for Information Interchange (ASCII) scrambler to (e) associate each of the 256 small PRNs with one of 256 standard ASCII codes ordered in ascending order, and (f) scramble the order of the standard ASCII codes, using the 256 small PRNs as the positions of the scrambled ASCII codes, to produce a dictionary;
using a distance calculator to count the distance between the positions of ASCII codes in the dictionary; and
using an encryption processor, connected to the key manager, the ASCII scrambler, and the distance calculator to use the dictionary to encrypt a plaintext by (g) reading a value of a first character in the dictionary, (h) using the value of the first character in the dictionary as a pointer to a second character in the dictionary, (j) calculating a first ciphertext character as an XOR operation between the value of the second character in the dictionary and a first character in the plaintext, (k) searching the dictionary for a next character in the dictionary with a value equal to the first ciphertext character, (l) using the distance calculator to calculate a first distance as a distance in positions of the second character in the dictionary and the next character in the dictionary, (m) reading a value of a third character in the dictionary by adding the first ciphertext character to the position of the second character in the dictionary, (n) repeating steps (j)-(m) using the value of a new third character in the dictionary calculated at each repetition of step (m) until a distance is calculated for each character in the plaintext, and (n) exporting a distancetext containing all distances in their order of calculation.

8. The computer implemented method of claim 7, further comprising swapping (o) the value of the first character in the dictionary with the value of the second character in the dictionary, after the execution of step (h), and (p) the value of the second character in the dictionary with the value of the third character in the dictionary at every repetition of step (n).

9. The computer implemented method of claim 7, wherein steps (k)-(l) are calculated as a look up operation in a position string.

10. The computer implemented method of claim 9, wherein the position string is calculated by (iii) using a value of a character in the dictionary as a pointer to a position in the position string, and (iv) filling a value of the position in the position sting with the position of the character in the dictionary.

11. A computer implemented method for decrypting distancetext, comprising:
using a key manager to (a) receive a public key, (b) use the public key to create a private key, and (c) send the private key to a Pseudo Random Number Generator (PRNG) for producing at least one big Pseudo Random Number (PRN), and (d) use the at least one big PRN to produce 256 small PRNs in the range of (0 . . . 255) by one of (i) splitting the at least one big PRN to a plurality of smaller PRNs and applying a (mod 256) operation to each of the plurality of smaller PRNs, and (ii) applying a (mod 256) operation to each of the at least one big PRN;
using an American Standard Code for Information Interchange (ASCII) scrambler to (e) associate each of the 256 small PRNs with one of 256 standard ASCII codes ordered in ascending order, and (f) scramble the order of the standard ASCII codes, using the 256 small PRNs as the positions of the scrambled ASCII codes, to produce a dictionary; and
using a decryption processor, connected to the key manager, and the ASCII scrambler to (g) receive distancetext data, (h) use the dictionary to decrypt a plaintext by (j) reading a value of a first character in the dictionary, (k) use the value of the first character in the dictionary as a pointer to a second character in the dictionary, (l) calculate a first plaintext character as an XOR operation between the value of the second character in the dictionary and a third character in the dictionary, where the position of the third character in the dictionary is calculated by adding to the position of the second character in the dictionary the first character in the distancetext data, (m) read a value of a fourth character in the dictionary by adding the value of the third character in the dictionary to the position of the second character in the dictionary, (n) repeat step (l) using the value of a new third character in the dictionary calculated at each repetition of step (m) until a plaintext character is calculated for each character in the distancetext data, and (o) export a plaintext containing all plaintext characters in their order of calculation.

12. The computer implemented method of claim 11, further comprising swapping (p) the value of the first character in the dictionary with the value of the second character in the dictionary, after the execution of step (k), and (q) the value of the second character in the dictionary with the value of the fourth character in the dictionary at every repetition of step (n).

13. A non-transitory computer program product for encrypting plaintext, the non-transitory computer program product comprising instructions to cause a computing apparatus to:
use a key manager, to (a) create a public key, (b) use the public key to create a private key, and (c) send the private key to a Pseudo Random Number Generator (PRNG) for producing at least one big Pseudo Random Number (PRN), and (d) using the at least one big PRN to produce 256 small PRNs in the range of (0 . . . 255) by one of (i) splitting the at least one big PRN to a plurality of smaller PRNs and applying a (mod 256) operation to each of the plurality of smaller PRNs, and (ii) applying a (mod 256) operation to each of the big PRNs;
use an American Standard Code for Information Interchange (ASCII) scrambler to (e) associate each of the 256 small PRNs with one of 256 standard ASCII codes ordered in ascending order, and (f) scramble the order of the standard ASCII codes, using the 256 small PRNs as the positions of the scrambled ASCII codes, to produce a dictionary;
use a distance calculator to count the distance between the positions of ASCII codes in the dictionary; and
use an encryption processor, connected to the key manager, the ASCII scrambler, and the distance calculator to use the dictionary to encrypt a plaintext by (g) reading a value of a first character in the dictionary, (h) using the value of the first character in the dictionary as a pointer to a second character in the dictionary, (j) calculating a first ciphertext character as an XOR operation between the value of the second character in the dictionary and a first character in the plaintext, (k) searching the dictionary for a next character in the dictionary with a value equal to the first ciphertext character, (l) using the distance calculator to calculate a first distance as a distance in positions of the second character in the dictionary and the next character in the dictionary, (m) reading a value of a third character in the dictionary by adding the first ciphertext character to the position of the second character in the dictionary, (n) repeating steps (j)-(m) using the value of a new third character in the dictionary calculated at each repetition of step (m) until a distance is calculated for each character in the plaintext, and (o) exporting a distancetext containing all distances in their order of calculation.

14. The non-transitory computer program of claim 13, further comprising instructions to cause the ASCII scrambler to swap (p) the value of the first character in the dictionary with the value of the second character in the dictionary, after the execution of step (h), and (q) the value of the second character in the dictionary with the value of the third character in the dictionary at every repetition of step (n).

15. The non-transitory computer program of claim 13, wherein steps (k)-(l) are calculated as a look up operation in a position string.

16. The non-transitory computer program of claim 15, wherein the position string is calculated by (iii) using a value of a character in the dictionary as a pointer to a position in the position string, and (iv) filling a value of the position in the position sting with the position of the character in the dictionary.

17. The non-transitory computer program of claim 13, wherein the small PRNs and the ASCII codes are selected from one of (v) a set with less than 256 items, and (vi) a set with more than 256 items.

18. A non-transitory computer program product for decrypting distancetext, the non-transitory computer program product comprising instructions to cause a computing apparatus to:
use a key manager to (a) receive a public key, (b) use the public key to create a private key, and (c) send the private key to a Pseudo Random Number Generator (PRNG) for producing at least one big Pseudo Random Number (PRN), and (d) use the at least one big PRN to produce 256 small PRNs in the range of (0 . . . 255) by one of (i) splitting the at least one big PRN to a plurality of smaller PRNs and applying a (mod 256) operation to each of the plurality of smaller PRNs, and (ii) applying a (mod 256) operation to each of the at least one big PRN;
use an American Standard Code for Information Interchange (ASCII) scrambler to (e) associate each of the 256 small PRNs with one of 256 standard ASCII codes ordered in ascending order, and (f) scramble the order of the standard ASCII codes, using the 256 small PRNs as the positions of the scrambled ASCII codes, to produce a dictionary; and
use a decryption processor, connected to the key manager, and the ASCII scrambler to (g) receive a distancetext data, (h) use the dictionary to decrypt a plaintext by (j) reading a value of a first character in the dictionary, (k) use the value of the first character in the dictionary as a pointer to a second character in the dictionary, (l) calculate a first plaintext character as an XOR operation between the value of the second character in the dictionary and a third character in the dictionary, where the position of the third character in the dictionary is calculated by adding to the position of the second character in the dictionary the first character in the distancetext data, (m) read a value of a fourth character in the dictionary by adding the value of the third character in the dictionary to the position of the second character in the dictionary, (n) repeat step (l) using the value of a new third character in the dictionary calculated at each repetition of step (m) until a plaintext character is calculated for each character in the distancetext data, and (o) export a plaintext containing all plaintext characters in their order of calculation.

19. The non-transitory computer program product of claim 18, further comprising instructions to cause the ASCII scrambler to swap (p) the value of the first character in the dictionary with the value of the second character in the dictionary, after the execution of step (k), and (q) the value of the second character in the dictionary with the value of the fourth character in the dictionary at every repetition of step (n).

20. The non-transitory computer program product of claim 18, wherein the small PRNs and the ASCII codes are selected from one of (iii) a set with a length of less than 256 items, and (iv) a set with a length of more than 256 items.
